(19) United States
(12) Patent Application Publication
(10) Pub. No.: US 2007/0068007 A1
(43) Pub. Date: Mar. 29, 2007

(54) Buffering member retaining device for a pair of hairdressing scissors

(76) Inventor: Wen-Ya Yeh, Tainan City (TW)

Correspondence Address: PRO-TECHTOR INTERNATIONAL SERVICES, 20775 NORADA CT., SARATOGA, CA, 95070, US

(21) Appl. No.: 11/234,689

(22) Filed: Sep. 23, 2005

(51) Int. Cl. B26B 13/00

(52) U.S. Cl. 30/271

(57) ABSTRACT

A buffering member retaining device for a pair of hairdressing scissors, comprises: a first handle portion, a second handle portion pivotally connected to the first handle portion, and a buffering member is affixed to one of the first and second handle portions by a retaining member. When the first and second handle portions move close to each other, the buffering member will press against the abutment surface of another one of the first and second handle portions, thus preventing the two handle portions from impacting each other and causing noise. The retaining member is partially embedded in the buffering member and partially protrudes out of the buffering member. The buffering member is defined with a slot through which a screwdriver is allowed to rotate the retaining member.

### BACKGROUND OF THE INVENTION

1. Field of the Invention

The present invention relates to a buffering member retaining device for a pair of hairdressing scissors, wherein the buffering member is affixed to one of the first and second handle portions, when the first and second handle portions move close to each other, the contact portion of the buffering member affixed at one of the first and second handle portions will press against an abutment surface of another one of the first and second handle portions.

2. Description of the Prior Art

To prevent two handle portions of a pair of hairdressing scissors from impacting each other and causing noise, one of the handle portions of the hairdressing scissors is usually provided with a buffering member. For example, U.S. Pat. No. 6,928,740B1 discloses such a pair of hairdressing scissors 100, as shown in FIG. 1, which comprises a first handle portion 200 pivoted to a second handle portion 300. The first handle portion 200 and the second handle portion 300 each includes an annular portion 201, 301. The annular portion 201 is formed with a threaded hole 202 for screwing with a base 500. An end of the base 500 is a threaded portion 501 to be screwed in the threaded hole 202, and another end of the base 500 is formed with a recess 502 for reception of a buffering member 600.

The annular portions 201 and 301 are provided for insertion of the fingers of the user. When the two handle portions 200 and 300 move close to each other, the buffering member 600 will press against the second handle portion 300, so that the two handle portions can be prevented from impacting each other and causing noise.

However, when the user closes the hairdressing hairs too fast or too hard, the buffering member 600 is likely to be damaged or to disengage from the recess 502 of the base 500.

The present invention has arisen to mitigate and/or obviate the afore-described disadvantages.

### SUMMARY OF THE INVENTION

The primary objective of the present invention is to provide a buffering member retaining device for a pair of hairdressing scissors, which comprises: a first handle portion, a second handle portion pivotally connected to the first handle portion, and a buffering member is affixed to one of the first and second handle portions by a retaining member. The retaining member has a shaft portion and a head portion. The buffering member has a through hole, and at an end of the buffering member is formed a cavity in communication with through hole. Around the periphery of the cavity is a contact portion. The shaft portion passes through the cavity and the through hole and then is inserted in the connecting hole of one of the handle portions. The head portion will be engaged in the cavity, and the buffering member will be affixed to the abutment surface of the annular portion of another one of the handle portions. When two handle portions move close to each other, the contact portion of the buffering member on one of the two handle portions will press against the abutment surface of another one of the two handle portions, thus preventing the two handle portions from impacting each other and causing noise.

The head portion of the retaining member can be embedded in the buffering member, and the shaft portion of the retaining member protrudes out of the buffering member.

The buffering member is defined with a slot through which a screwdriver is allowed to rotate the retaining member.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is an enlarged view of showing a buffering member retaining device of a conventional hairdressing scissors disclosed in U.S. Pat. No. 6,928,740B1;

FIG. 2 shows a pair of hairdressing scissors in accordance with a first embodiment of the present invention;

FIG. 3 is an exploded view of showing a buffering member retaining device for a pair of hairdressing scissors in accordance with the first embodiment of the present invention;

FIG. 4 is an enlarged exploded view showing the buffering member retaining device for a pair of hairdressing scissors in accordance with the first embodiment of the present invention;

FIG. 5 is a cross sectional view showing the buffering member retaining device for a pair of hairdressing scissors in accordance with the first embodiment of the present invention;

FIG. 6 is an exploded view of showing a buffering member retaining device for a pair of hairdressing scissors in accordance with a second embodiment of the present invention;

FIG. 7 is a plan view of showing a head portion of the buffering member retaining device for a pair of hairdressing scissors in accordance with the second embodiment of the present invention;

FIG. 8 is a plan view of showing another type head portion of the buffering member retaining device for a pair of hairdressing scissors in accordance with the second embodiment of the present invention;

FIG. 9 is a cross sectional view showing the buffering member retaining device for a pair of hairdressing scissors in accordance with the second embodiment of the present invention;

FIG. 10 is an exploded view of showing another type buffering member retaining device for a pair of hairdressing scissors in accordance with the second embodiment of the present invention;

FIG. 11 is a cross sectional view showing the buffering member retaining device for a pair of hairdressing scissors of FIG. 10; and

FIG. 12 shows a pair of hairdressing scissors in accordance with another embodiment of the present invention.

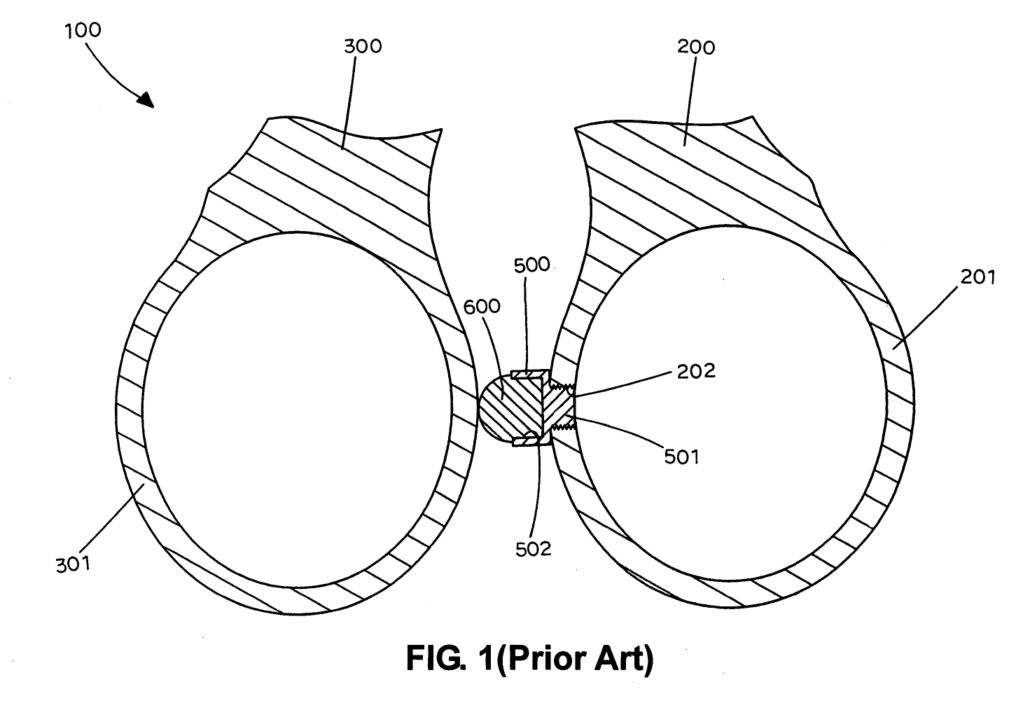

### DETAILED DESCRIPTION OF THE PREFERRED EMBODIMENTS

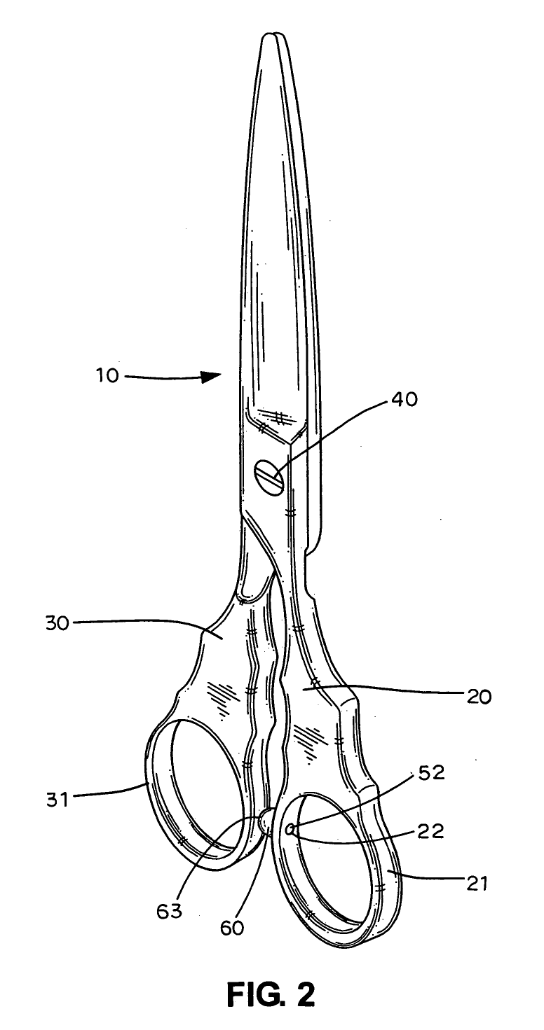

Referring to FIG. 2, a pair of hairdressing scissors 10 in accordance with a first embodiment of the present invention is shown and comprises a first handle portion 20 and a second handle portion 30 each is formed at an end thereof with an annular portion 21, 31. The first handle portion 20 is pivotally connected to the second handle portion 30 by a pivot 40, and the user can close and open the hairdressing scissors 10 by inserting fingers in the annular portions 21 and 31, respectively.

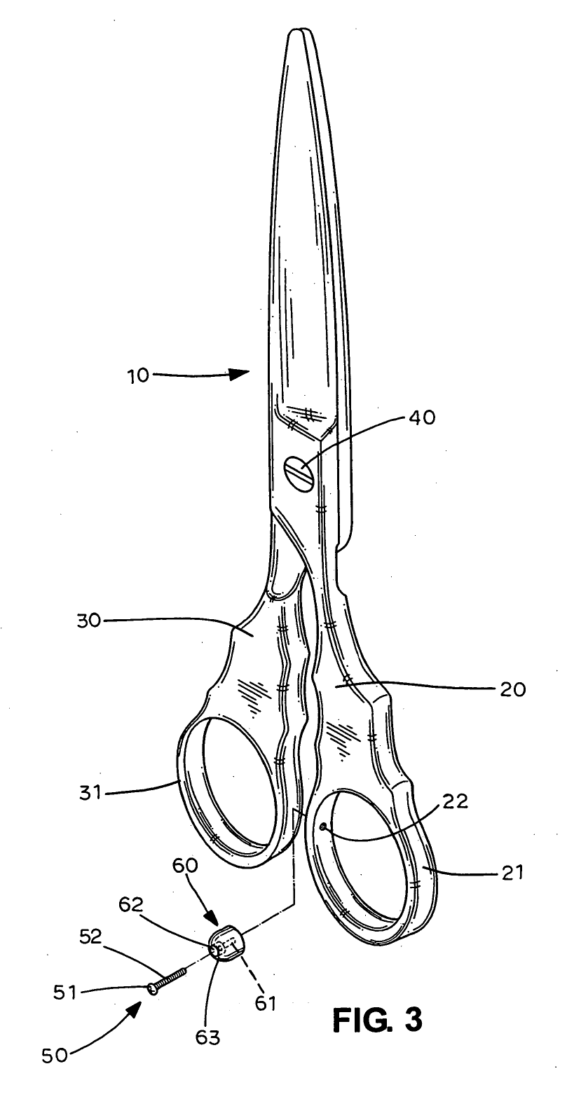

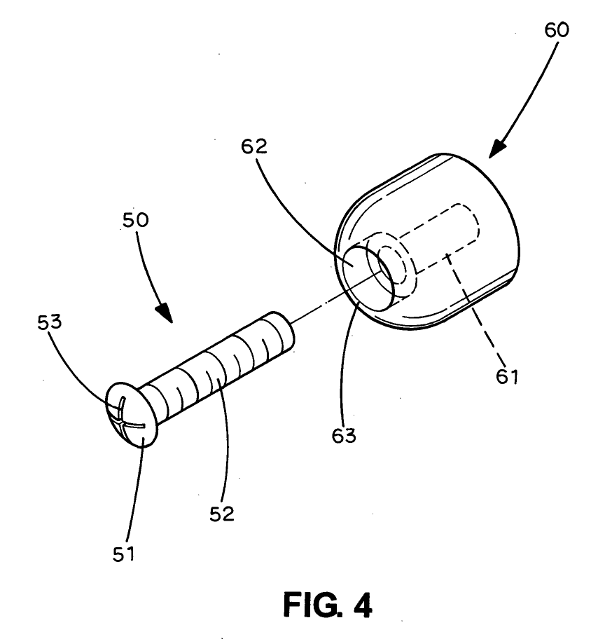

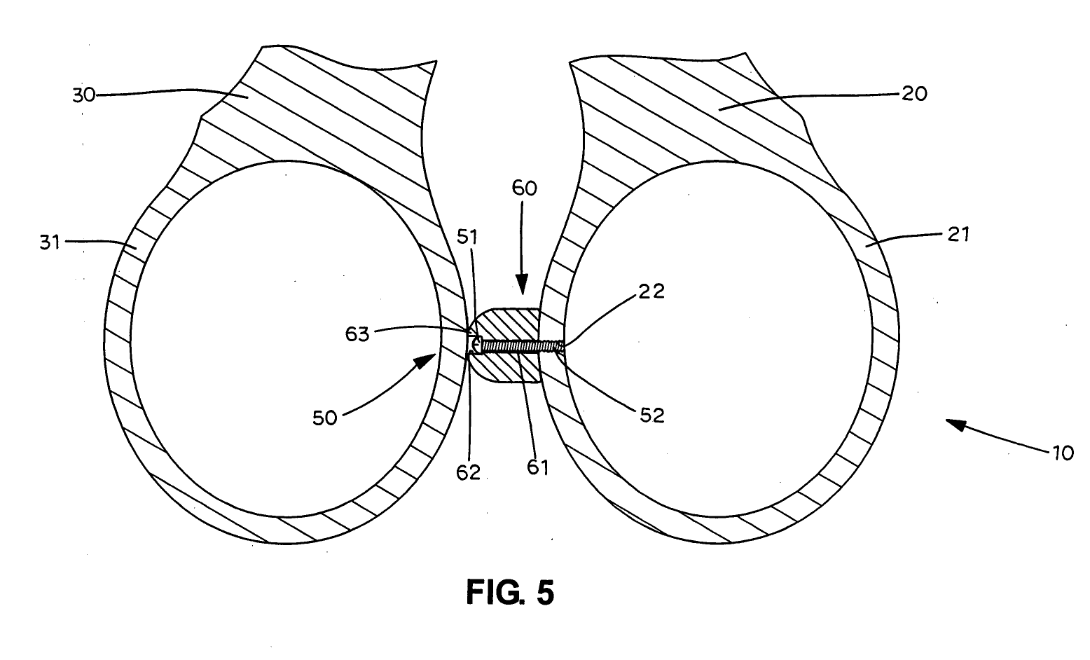

Referring to FIGS. 3 and 4, the annular portion 21 is formed with a connecting hole 22, to an abutment surface of the annular portion 21 against the annular portion 31 is affixed a retaining member 50 for retaining a buffering member 60. The retaining member 50 includes a head portion 51 and a shaft portion 52 whose outer diameter is smaller than that of the head portion 51. The buffering member 60 is made of flexible material, such as flexible plastic or rubber. The buffering member 60 is defined with a through hole 61, and at an end of the buffering member 60 is formed a cavity 62 in communication with through hole 61. Around the periphery of the cavity 62 is a contact portion 63. The shaft portion 52 passes through the cavity 62 and the through hole 61 and then is inserted in the connecting hole 22, as shown in FIG. 5. The head portion 51 will be engaged in the cavity 62, and the buffering member 60 will be affixed to the abutment surface of the annular portion 21. When the first and second handle portions 20 and 30 move close to each other, the contact portion 63 will press against the abutment surface of the annular portion 31, preventing the two handle portions 20 and 30 from impacting each other and causing noise.

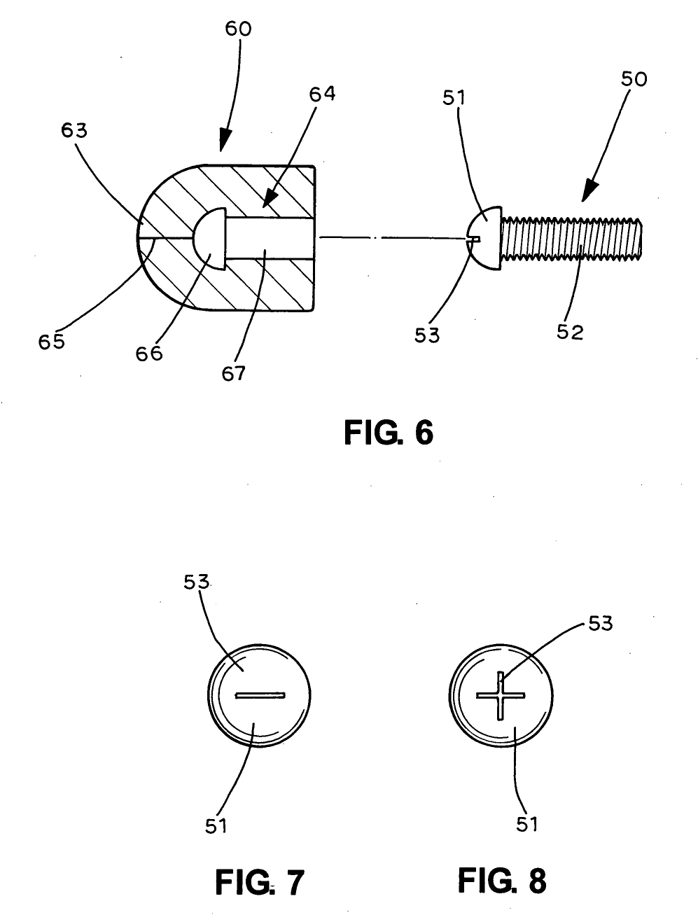

The method of affixing the buffering member 60 to the hairdressing scissors 10 also can be varied, with reference to FIG. 6, a buffering member retaining device for a pair of hairdressing scissors in accordance with a second preferred embodiment of the present invention is shown, in which, the buffering member 60 includes a T-shaped hole 64 that has a large portion 66 and a small portion 67. The retaining member 50 is inserted in the T-shaped hole 64 in such a manner that the head portion 51 is received in the large portion 66 and the shaft portion 52 is partially accommodated in the small portion 67 and partially protrudes out of an end of the buffering member 60 so as to be positioned in the connecting hole 22 of the annular portion 21.

The shaft portion 52 can be screwed in the connecting hole 22, that is, the shaft portion 52 is a screw shaft and the connecting hole 22 is a threaded hole, or they can be connected by other means, for example, by friction, soldering or adhering.

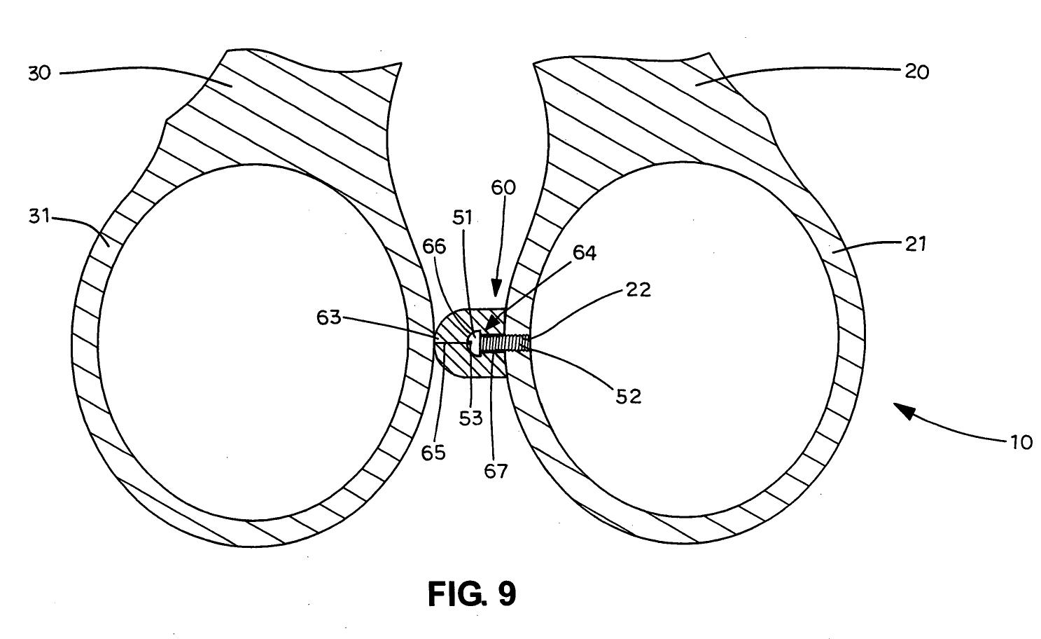

At another end of the buffering member 60 is formed a straight or a cross slot 65 that is in communication with the large portion 66 of the T-shaped hole 64 and is aligned to the straight slot or cross slot 53 of the head portion 51 (as shown in FIGS. 7 and 8), so that, through the slot 65, a screwdriver or similar tools can be engaged in the straight or cross slot 53 of the head portion 51 to screw the retaining member 50 and the buffering member 60 in the annular portion 21 (as shown in FIG. 9).

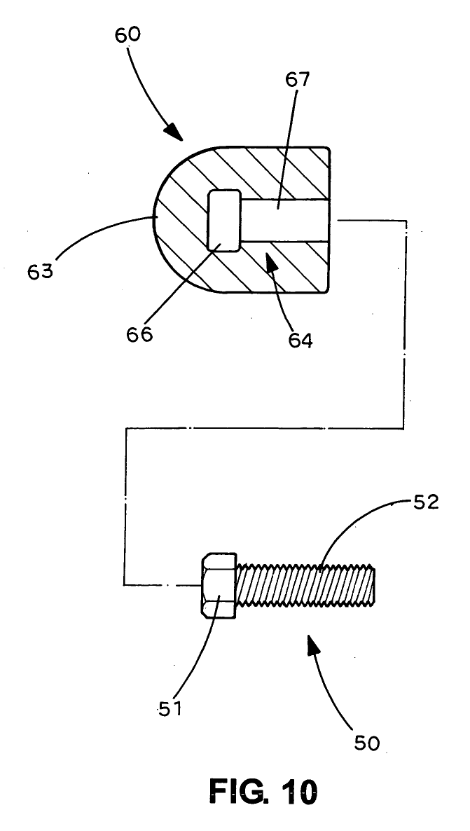

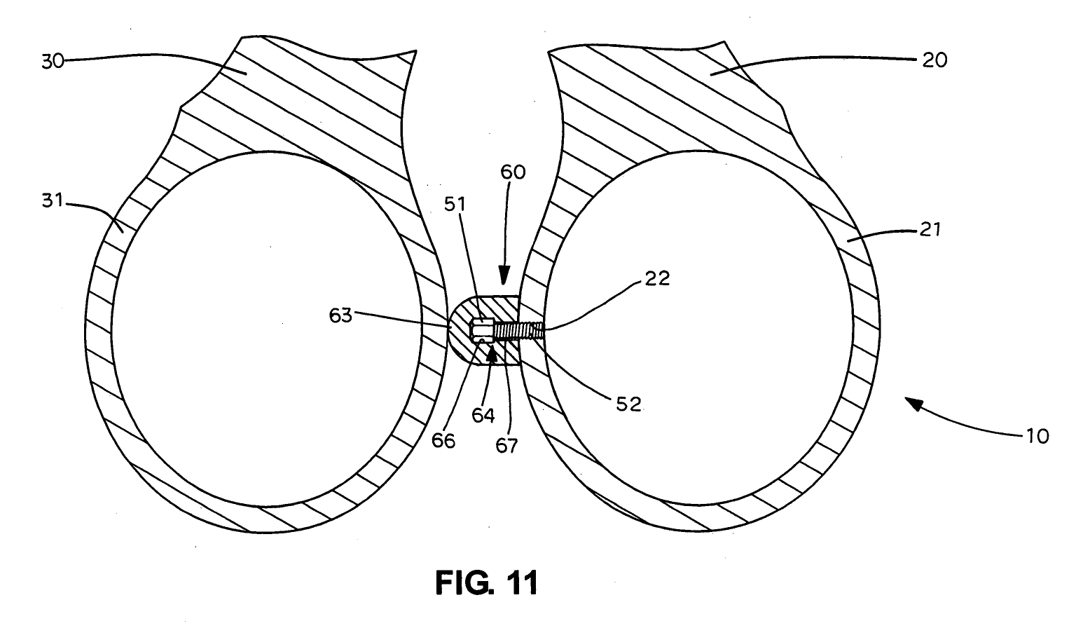

Referring to FIGS. 10 and 11, the head portion 51 of the retaining member 50 can be noncircular, for example, it can be quadrangle, pentangle, hexagonal, octagonal or elliptical, so that the retaining member 50 can be rotated without using screwdriver or similar tools. The large portion 66 of the T-shaped hole 64 is formed correspondingly for mating with the head portion 51 of the retaining member 50, so that the buffering member 60 can be rotated together with the retaining member 50.

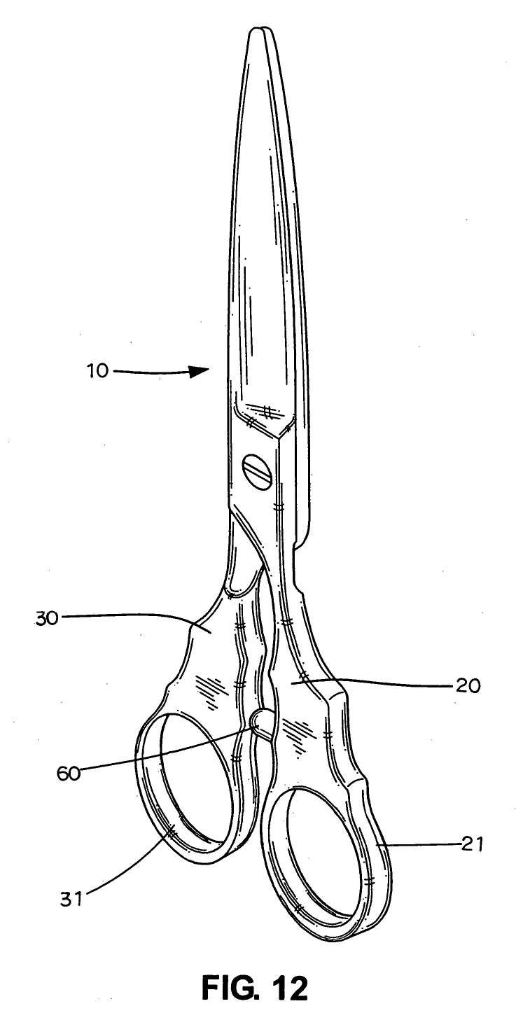

The buffering member 60 also can be affixed to the abutment surface of the handle portion 20 or 30, as shown in FIG. 12. Since the first and second handle portions 20 and 30 include the annular portions 21 and 31, the abutment surface of the annular portions 21 and 31 also can be considered as a part of the abutment surface of the first and second handle portions 20 and 30.

The buffering member 60 of the first embodiment is pressed against the handle portion 20 or 30 by the retaining member 50, and the buffering member 60 of the second embodiment closely wraps up the retaining member 50, and therefore, the joint between the buffering member 60 and the retaining member 50 is very strong.

While we have shown and described various embodiments in accordance with the present invention, it should be clear to those skilled in the art that further embodiments may be made without departing from the scope of the present invention.

What is claimed is:

1. A buffering member retaining device for a pair of hairdressing scissors comprising:
a first handle portion;
a second handle portion pivotally connected to the first handle portion;
a connecting hole formed in one of the first and second handle portions;
a buffering member having a cavity formed at an end thereof, and a contact portion formed around the cavity; and
a retaining member having a head portion inserted through the buffering member and fixed in the connecting hole, wherein the head portion is received in the cavity, the buffering member is affixed to one of the first and second handle portions, when the first and second handle portions move close to each other, the contact portion of the buffering member will press against an abutment surface of another one of the first and second handle portions.

2. The buffering member retaining device for a pair of hairdressing scissors as claimed in claim 1, wherein the retaining member further comprises a shaft portion that passes through the buffering member and is fixed in the connecting hole.

3. The buffering member retaining device for a pair of hairdressing scissors as claimed in claim 2, wherein the shaft portion is screwed in the connecting hole.

4. The buffering member retaining device for a pair of hairdressing scissors as claimed in claim 1, wherein the buffering member is made of flexible material.

5. A buffering member retaining device for a pair of hairdressing scissors comprising:
a first handle portion;
a second handle portion pivotally connected to the first handle portion;
a connecting hole formed in one of the first and second handle portions;
a buffering member formed with a T-shaped hoe; and
a retaining member positioned in the T-shaped hole of the buffering member, the retaining member has a shaft portion positioned in the connecting hole, and the buffering member is affixed to one of the first and second handle portions, when the first and second handle portions move close to each other, the buffering member will press against an abutment surface of another one of the first and second handle portions.

6. The buffering member retaining device for a pair of hairdressing scissors as claimed in claim 5, wherein the shaft portion is screwed in the connecting hole.

7. The buffering member retaining device for a pair of hairdressing scissors as claimed in claim 6, wherein the buffering member is defined with a slot through which a screwdriver is allowed to rotate the retaining member.

8. The buffering member retaining device for a pair of hairdressing scissors as claimed in claim 5, wherein the T-shaped hole of the buffering member has a large portion for accommodation of a head portion of the retaining member.

9. The buffering member retaining device for a pair of hairdressing scissors as claimed in claim 8, wherein the head portion of the retaining member is noncircular, and the large portion of the T-shaped hole is shaped correspondingly for mating with the head portion of the retaining member.

10. The buffering member retaining device for a pair of hairdressing scissors as claimed in claim 5, wherein the buffering member is made of flexible material.
